(19) United States
(12) Patent Application Publication
(10) Pub. No.: US 2007/0243030 A1
(43) Pub. Date: Oct. 18, 2007

(54) Unequal Helical Flute Thread Mill

(76) Inventors: Ronald Staedt, Murfreesboro, TN (US); Frank Stanbach, Greenville, SC (US)

Correspondence Address: Frank Stanbach, 6 Spyglass Ct, Greenville, SC, 29609, US

(21) Appl. No.: 11/279,960

(22) Filed: Apr. 17, 2006

(51) Int. Cl. B23G 1/32; B23C 5/10

(52) U.S. Cl. 407/61; 407/56; 409/65

(57) ABSTRACT

A thread milling tool having a proximal shank portion a distal cutting portion and a deferential flute construction with all the individual helical flutes being unequally spaced about the circumference of the cylindrical tool body. The cutting portion of the tool may be configured to cut internal or external threads in a work piece.

### BACKGROUND OF THE INVENTION

The invention relates to cutting tools for milling internal and external threads; internal threads in predrilled holes and external threads on the perimeter of a work piece or part. The invention further relates to design features that will enhance the performance of thread mills; said features are unequal non-intersecting helical flutes.

Typically a thread mill produces a higher quality thread than a tap. A typical thread mill will have 2 to 5 flutes and the flutes will be straight or helical. Straight flutes lie parallel to the axis of the tool and helical flutes are generally at 20 degree to 40-degree angles and wrap around the external surface of the tool body. Helical thread mills provide for improved chip control and chip evacuation. Helical thread mills present the cutting teeth to the work piece in an interrupted configuration. The combination of the improved chip evacuation and interrupted work piece contact results in improved performance as described in U.S. Pat. No. 6,345,941.

Though thread mills have evolved with design enhancements, there are areas where lack of rigidity or operational parameters result in a condition where vibration and resulting chatter leave the work piece with an unacceptable surface finish. The invention of helical flutes combined with unequal flute spacing works to reduce harmonics, vibration and improve operational conditions.

The concept of unequal flute spacing has become a proven technology within the metal cutting industry. End mill manufacturers have used this technique very successfully to improve tool performance by reducing harmonics and vibration, one example is explained in U.S. Pat. No 6,899,494.

### SUMMARY OF THE INVENTION

The present invention provides a unique construction of a thread milling tool providing improved tool performance by reducing harmonics and vibration. In comparison test with other commercially available thread mills, the present thread mill provided less noise, harmonics, and vibration.

It is the object of the invention to provide improved thread milling performance.

It is the object of the invention to reduce vibration resulting in improved surface finish on the work piece.

It is the object of the invention to provide improved chip flow.

### DETAILED DESCRIPTION OF THE INVENTION

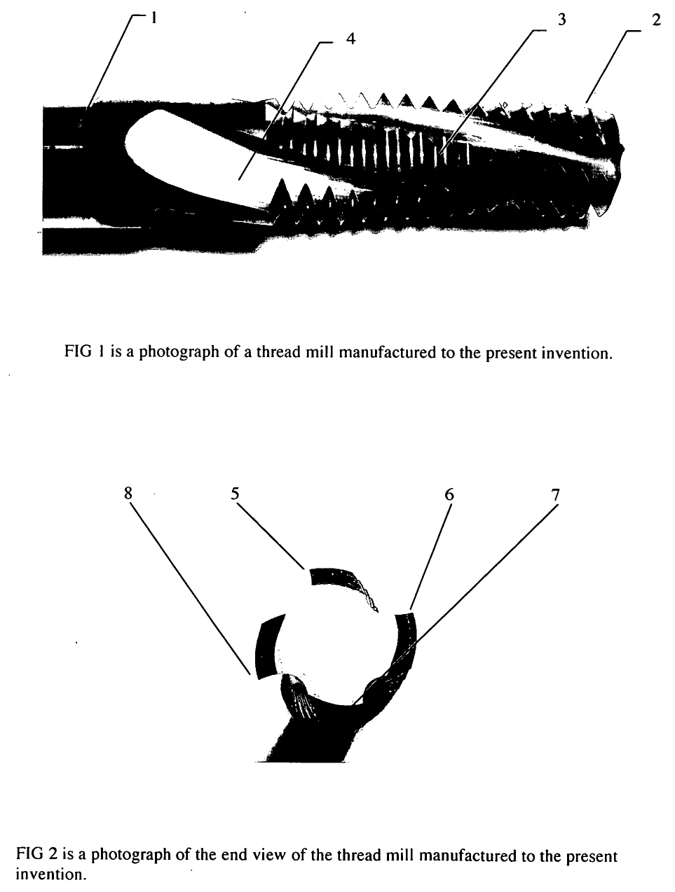

The cutting tool, thread mill shown in FIG. 1 is constructed to embody the elements of the present invention. The figure consist of a shank portion 1 and a cutting portion 2. The thread milling teeth 3 are oriented along the 20-degree helical flute 4 and are determined by the specific thread form to be produced. FIG. 2 is an end view of a 4 flute thread mill constructed to embody the elements of the present invention. The figure consist of flute 1 at 0 degree 5; flute 2 at 85 degrees 6; flute 3 at 180 degrees 7; flute 4 at 265 degrees 8.

The present invention is a thread milling tool to create internal and external threads on metallic parts or parts made of other materials. The unequal helical flute design is intended to provide an action that will aid in evacuation of chips from the work piece. The unequal helical flute configuration is intended to provide reduced chatter harmonics to provide improved surface finishes on the work piece.

The bank of cutting teeth 3 can be configured to cover various thread forms conforming to ISO and International standard thread forms in inch or metric sizes, and any specific variations. Typically UN, UNJ, NT and NTP are the most common thread forms found on thread mills.

The thread mill shown is constructed on material of cemented tungsten carbide; other materials can be used such as high speed steel, cobalt steel, powder metal and other materials. The application of these materials is dependent on the application of the tool.

These tools are used to produce threads on a part as per the determined thread configuration being ISO or other standard thread form. The thread mill invention is placed in a suitable holder and then in a CNC machining center where the internal thread is produced in a predrilled hole. The thread mill rotates and in an interpolated cutting mode imparts the thread form to the work piece through cutting action of the teeth 3. External threads are produced on a work piece where the thread mill rotates and in an interpolated cutting mode imparts the thread form to the perimeter of the work piece through cutting action of the teeth 3.

The unequal helical flutes provide for chip evacuation, reduced cutting force and reduced chatter harmonics. The result is an improved thread form produced on the work piece.

The present inventors have discovered that in test of thread mills M14-1.50 made according to the present invention was able to reduce chatter harmonics and vibration during the machining process and produce an improved finish on the work piece.

It is to be understood that the present description illustrates those aspects of the invention relevent to a clear understanding of the invention. It is to be understood that further embodiments of the present invention are also contemplated and the invention is intended to cover all variations of the disclosed tool construction which may be devised by persons skilled in the art as falling within the scope of the herein claimed invention.

1. A thread milling tools having a cylindrical body with a shank end and a cutting end. The cutting portion comprises a plurality of thread milling teeth on at least one helical flute. The helical flute is defined by a helix angle of 20 degrees. The non-intersecting helical flutes are oriented in unequal spacing to reduce vibration harmonics during the machining process.

2. The thread milling tool of claim 1 will have thread milling teeth which will produce a thread on a work piece conforming to various thread standards.

3. The thread milling tool of claim 2 will be attached to a holding device in a machine tool that will transfer the thread milling form to the work piece.

4. The thread milling tool of claim 1 having an odd number of helical flutes.

5. The thread milling tool of claim 1 having an even number of helical flutes.

6. The thread milling tool of claim 1 having a wear-resistant surface coating on the cutting end.

7. The thread milling tool of claim 1 wherein the shank portion comprises a Weldon shank.

8. The thread milling tool of claim 1 wherein the shank portion comprises a flat locking section.

9. The thread milling tool of claim 1 having 3 non-intersecting helical flutes unequally spaced about the circumference the first helical flute being placed at the zero position on said circumference, the second helical flute being placed at 125 degrees on said circumference, the third helical flute being placed 243 degrees on said circumference, said helical flutes and unequal spacing combine to reduce harmonic vibration during the machining process.

10. The thread milling tool of claim 1 having 4 non-intersecting helical flutes unequally spaced about the circumference, the first helical flute being placed at the zero position on said circumference, the second helical flute being placed at 85 degrees on said circumference, the third helical flute being placed 180 degrees on said circumference, the forth helical flute being placed 265 degrees on said circumference, said helical flutes and unequal spacing combine to reduce harmonic vibration during the machining process.

11. The thread milling tool of claim 1 having 5 non-intersecting helical flutes unequally spaced about the circumference, the first helical flute being placed at the zero position on said circumference, the second helical flute being placed at 72 degrees on said circumference, the third helical flute being placed 134 degrees on said circumference, the forth helical flute being placed 223 degrees on said circumference, the fifth helical flute being placed 295 degrees on said circumference, said helical flutes and unequal spacing combine to reduce harmonic vibration during the machining process.
